(19) United States
(12) Patent Application Publication
(10) Pub. No.: US 2024/0051162 A1
(43) Pub. Date: Feb. 15, 2024

(54) HAIR CUTTER CAP AND HAIR CUTTER WITH CAP

(71) Applicant: KONINKLIJKE PHILIPS N.V., Eindhoven (NL)

(72) Inventors: Maurits KOENEN, DRACHTEN (NL); Geert Willem DE GOEIJ, DRACHTEN (NL)

(21) Appl. No.: 18/270,912

(22) PCT Filed: Dec. 2, 2021
(86) PCT No.: PCT/EP2021/083969

§ 371 Date: Jul. 5, 2023

(30) Foreign Application Priority Data
Jan. 7, 2021 (CN) 2021200404975

(51) Int. Cl. B26B 19/38

(52) U.S. Cl. CPC B26B 19/3813

(57) ABSTRACT

A cap for a hair cutter and a corresponding hair cutter is provided. The cap (10) comprises a body (12) comprising a main surface (120) facing towards a subject; and a protrusion (14) protruding from the main surface (120) along a first direction (L1) perpendicular to the main surface (120). The protrusion (14) comprises a plurality of ribs (140) extending along a second direction (L2) perpendicular to the first direction (L1), the plurality of ribs (140) parallel to each other and spaced apart from each other in a third direction (L3) perpendicular to the first and second directions (L1, L2).

### FIELD OF THE INVENTION

The present disclosure relates to the personal care field, and more specifically, to a cap for a hair cutter and a corresponding hair cutter.

### BACKGROUND OF THE INVENTION

In the field of personal care, the users usually use various types of personal care devices for skin and hair treatment. Such personal care devices often include, for example, a blade rotary component that contacts with the skin or the hair of the users. Since the skin of the human body is not entirely flat and smooth, the blade, when moving on the skin, may cause the skin to bulge. The issues may become more prominent at sensitive or relatively soft areas of the skin. As such, the devices may induce skin scratch, skin cut, pain and reduced performance in hair cutting, and there is a still a risk for skin irritation and even skin injury.

Some methods have been proposed to improve the contact between the skin of the user and the personal care devices. For example, in patent application No. WO 2018/228850 A1, a hair cutting system includes a cutting head and an accessory releasably attached thereto. A first lateral portion and a second lateral portion are provided at both ends of the accessory. A recessed portion is also disposed between the two ends. The proportion of the length of the recessed portion in the cutting area of the accessory is also adjustable. However, the manufacturing costs of the above solution are relatively high, and the promotion of the solution is also greatly limited since it is only suitable for the relatively dry skin.

### SUMMARY OF THE INVENTION

Embodiments of the present invention provide a hair cutter and a cap for a hair cutter, with the purpose of addressing the above and/or other potential problems existing in the current solution.

In the first aspect, embodiments of the present invention provide a cap for the hair cutter. The cap comprises: a body comprising a main surface facing towards a subject; and a protrusion protruding from the main surface along a first direction perpendicular to the main surface, wherein the protrusion comprises a plurality of ribs extending along a second direction perpendicular to the first direction, the plurality of ribs parallel to each other and spaced apart from each other in a third direction perpendicular to the first and second directions.

In accordance with the embodiments of the present invention, the contact area between the cap and the skin of the object is reduced. This decreases the frictional resistance between the two surfaces to a large extent, and ensures that the cap can move more smoothly relative to the skin of the object, so as to avoid damage to the object skin.

In some embodiments, a first length of the main surface along the third direction is greater than a second length of the main surface along the second direction.

In some embodiments, each of the plurality of ribs has a width in the third direction, the width decreasing along the first direction when viewed in a section perpendicular to the second direction.

In some embodiments, each of the plurality of ribs comprises a lateral surface adjacent to the main surface of the body, an angle between the lateral surface and the main surface ranging from 90 to 140 degrees.

In some embodiment, the body further comprises a first portion and a second portion, wherein the first portion and the second portion are separated from each other along the second direction or the third direction and each has a convex surface protruding outwardly from the main surface.

In some embodiments, the body further comprises an intermediate portion connecting the first portion and the second portion, the main surface being provided on the intermediate portion.

In some embodiments, each of the plurality of ribs comprises a top and a bottom, wherein a total surface area of the plurality of ribs at a section at a distance from the top is 10%-60% of a surface area of the main surface.

In some embodiments, the distance is 0.2 mm.

In some embodiments, the convex surfaces are circular surfaces.

In some embodiments, the plurality of the ribs are provided in parallel on the main surface with the same interval or different intervals.

In some embodiments, the cap also comprises a coating provided on the main surface.

In some embodiments, the cap is made of a thermoplastic material.

In a second aspect, the embodiments of the present invention relate to a hair cutter including the cap in accordance with the first aspect of the present invention.

### BRIEF DESCRIPTION OF THE DRAWINGS

Through the following detailed description with reference to the accompanying drawings, the above and other objectives, features, and advantages of the embodiments of the present invention will become more apparent. Several example embodiments of the present invention will be illustrated by way of example but not limitation in the drawings in which:

FIG. 1 illustrates a schematic perspective view of the cap in accordance with embodiments of the present invention;

FIG. 2 illustrates a schematic front view of the cap of FIG. 1;

FIG. 3 illustrates a schematic side view of the cap of FIG. 1;

FIG. 4 illustrates a schematic side view of the cap of FIG. 1 and a partial enlarged view of the rib;

FIG. 5 illustrates a schematic view of the particular section P of the cap in accordance with embodiments of the present invention; and

FIG. 6 illustrates a schematic sectional view of the cap of FIG. 5.

### DETAILED DESCRIPTION OF THE EMBODIMENTS

Principles of the present invention are now explained with reference to various example embodiments shown in the drawings. It should be appreciated that description of those embodiments is merely to enable those skilled in the art to better understand and further implement the present invention and is not intended for limiting the scope disclosed herein in any manner. It should be noted similar or same reference signs can be used in the drawings where feasible, and similar or same reference signs can represent similar or same functions. Those skilled in the art will easily understand from the following description that alternative embodiments of the structure and/or method described in the text can be adopted without deviating from the principles of the present invention described herein.

In description of embodiments of the present invention, the term “includes” and its variants are to be read as open-ended terms that mean “includes, but is not limited to.” The term “based on” is to be read as “based at least in part on.” The term “one example” or “this example” is to be read as “at least one embodiment.” The terms “first”, “second” and the like may indicate different or same objects. The following text may include other explicit and implicit definitions.

As described above, in the current design of the personal care devices, a great frictional resistance is present between the devices and the skin, forming wrinkles or projections on the skin. Such wrinkles or projections may scratch the skin of the user and forms a fissure during the skin care procedure, which degrades the user experience.

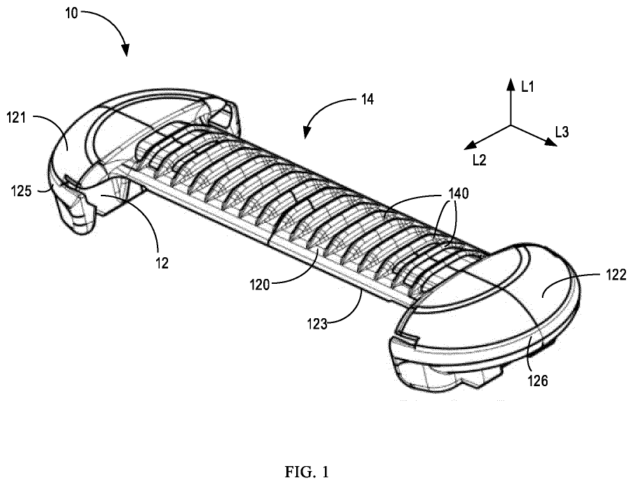

Some schematic implementations of the cap in accordance with the present invention are to be described hereinafter with reference to FIGS. 1 to 6 in conjunction with the usage scenarios of the hair cutter. It is to be understood that these implementations are exemplary only, and the cap in accordance with the present invention may be used in combination with other various types of personal care devices, e.g., shavers, epilators, skin trimmers etc.

FIGS. 1 to 4 illustrate schematic views of the cap 10 in accordance with embodiments of the present invention. The illustrated cap 10 may be connected to a blade of the hair cutter in different ways, so as to cover the blade and adapt to contact the skin of the object. As illustrated in FIG. 1, the cap 10 generally includes a body 12 and a projection 14 protruding from the body 12. The body 12 includes a main surface 120 facing the object. The object may be the user of the personal care device herein.

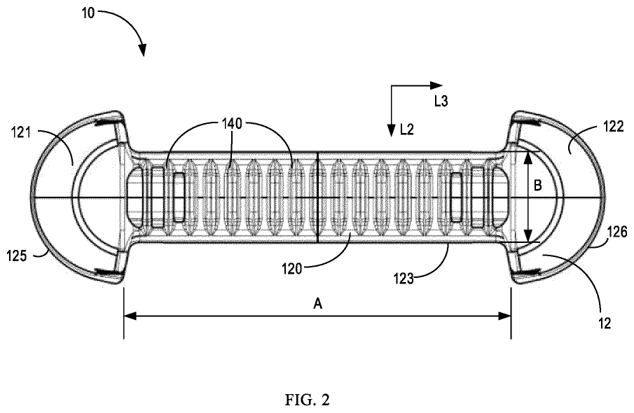

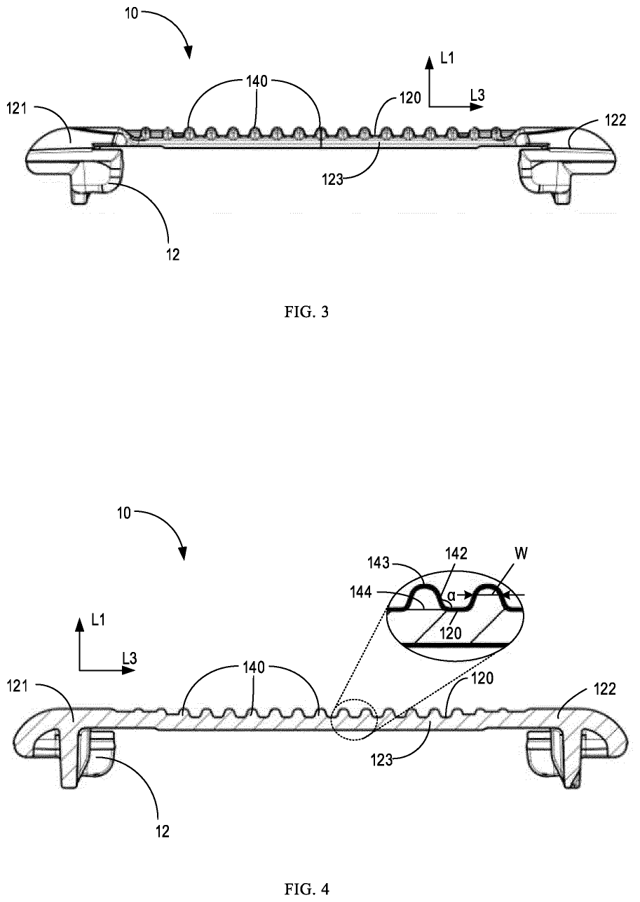

As shown in FIGS. 1 and 3, the projection 14 of the cap 10 protrudes from the main surface 120 in a first direction L1 perpendicular to the main surface 120, and includes a plurality of ribs 140. As shown in FIG. 2, these ribs 140 generally extend in a second direction L2 perpendicular to the first direction L1. These ribs 140 are parallel to the second direction L2. It is to be understood that the parallel here is not in the strict sense. Instead, the ribs 140 are only required to be substantially parallel to each other, or only the principle axes of the ribs 140 are substantially parallel to each other. As shown in FIG. 2, the ribs 140 are spaced apart from each other in a third direction L3 perpendicular to the first direction L1 and the second direction L2.

In accordance with the embodiments of the present invention, the plurality of ribs 140 are spaced apart from each other, and owing to the gaps therebetween, a projection area of the ribs 140 onto the main surface 120 is smaller than the area of the main surface 120. Since the ribs 140 in use will directly contact with the skin of the object, the above setting may reduce the contact area between the cap 10 and the skin of the object, so as to decrease the mutual slip between the skin and the hair cutter, and the frictional resistance therebetween may be decreased to a large extent accordingly. In this way, the cap 10 can move smoothly relative to the skin of the object.

In some embodiments, a first length A of the main surface 120 in the third direction L3 may be greater than a second length B of the main surface 120 in the second direction L2 as shown in FIG. 2. In this design, the longitudinal direction of the cap 10 is the third direction L3 in FIG. 2. These ribs 140 may extend along the longitudinal direction perpendicular to the cap 10. In other embodiments, the first length A of the main surface 120 in the third direction L3 may be smaller than the second length B of the main surface 120 in the second direction L2. In such a case, the longitudinal direction of the cap 10 may be the second direction L2, and the ribs 140 may extend along the longitudinal direction parallel to the cap 10. In some further examples, the parallel ribs 140 may extend along the diagonal direction of the main surface 120 of the cap 10. In other words, the ribs 140 may extend in any directions relative to the longitudinal direction of the cap 10. The extending direction may be designed in different ways according to the predetermined cutting direction of the hair cutter.

In accordance with the embodiments of the present invention, when the skin is moist, the cap 10 is shaped and dimensioned to reduce the slip effect of the cap 10 on the moist skin because a water film may be formed between the surface of the cap 10 and the skin when the contact area between the moist skin and the cap 10 is reduced. Compared to the traditional cap, the design of the cap 10 in accordance with embodiments of the present invention may reduce the frictional resistance between the two surfaces to a large extent.

In some embodiments, as shown in the enlarged view of FIG. 4, the plurality of ribs 140 each has a corresponding width W in the third direction L3. The width W of the ribs 140 may be decreased along the first direction L1 perpendicular to the main surface 120 when viewed from a section perpendicular to the second direction L2. In this way, the contact area between the cap 10 and the skin of the object may further be reduced, which not only saves the materials, but also decreases the frictional resistance between the cap 10 and the skin.

In the embodiments shown in FIG. 4, each of the plurality of ribs 140 may include two lateral surfaces 142 adjacent to the main surface 120 of the body 12, where an angle α is formed between the lateral surface 142 and the main surface 120. In some embodiments, the angle may range from 900 to 140°. In some embodiments, the angle α may be 110°. As such, the ribs 140 may be positioned at appropriate angles, and be oriented to ensure that the contact angle with the skin of the object would be neither too large nor too small. The hair cutter in the above arrangement may move on the skin of the object at a low resistance, to decrease the discomfort and damage to the skin caused by the hair cutter. The user experience is thus improved. The above effects become more prominent when the skin is moist. It should be appreciated that the above described range of the angle α is only exemplary and may vary according to the design requirements for different personal care devices. The present invention is not restricted in this regard.

In some embodiments, the body 12 also may include a first side portion 121 and a second side portion 122 separated from each other. FIG. 2 illustrates one implementation, in which the first side portion 121 and the second side portion 122 are separated along the longitudinal direction (i.e., third direction L3) of the cap 10, and the first side portion 121 and the second side portion 122 each have convex surfaces 125, 126 protruding outwardly from the main surface 120. In some further embodiments, the first side portion 121 and the second side portion 122 may be separated in a direction perpendicular to the longitudinal direction of the cap 10 in accordance with the different extending directions designed for the ribs 140 on the cap 10.

In some embodiments, the body 12 also may include an intermediate portion 123, which is provided between the first side portion 121 and the second side portion 122 and connecting both the portions, as shown in FIG. 2. The main surface 120 of the cap 10 may be provided on the intermediate portion 123. The shape of the body 12 designed in this way allows the cap 10 to match with more personal care devices for use.

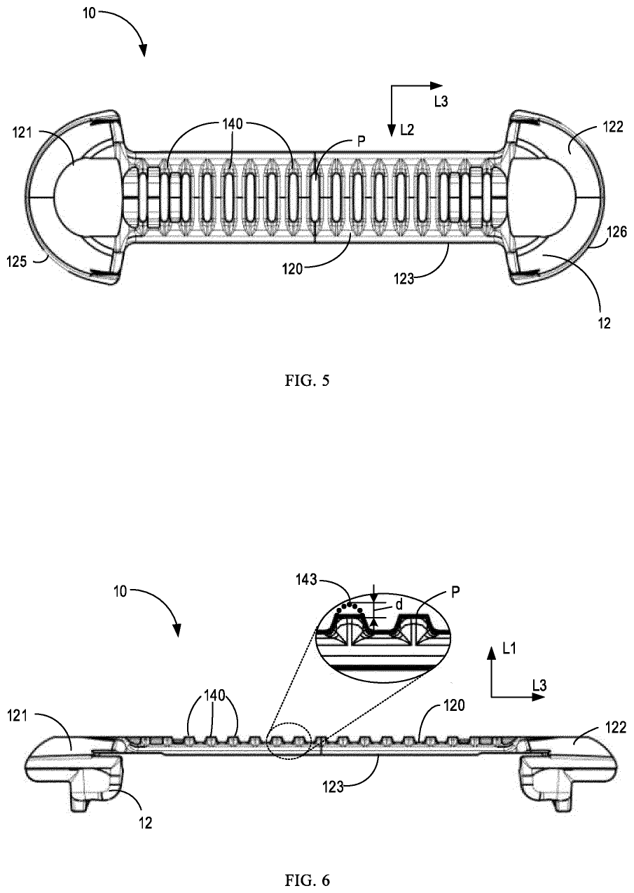

FIGS. 5 and 6 illustrate some implementations of the embodiments in accordance with the present invention. As shown in FIG. 6, the plurality of ribs 140 each includes a top 143 and a bottom 144, wherein the top 143 may have a smooth and curved shape. Compared to the sharp shapes, the smooth and curved shape may prevent the cap 10 from stinging the skin of the object.

Continuing to refer to FIG. 6, in the shown embodiment, a proportion a of a total surface area of the ribs 140 at a section P at a distance d from the top 143 to a surface area of the main surface 120 may range from 10% to 60%. In some embodiments, the distance d may be 0.2 mm as shown in FIG. 6. If the proportion a of the total surface area of the ribs 140 at a section P to the surface area of the main surface 120 is excessively small, the top 143 of the ribs may be too sharp, which may hurt the skin of the object. In case of a high proportion a, the contact area between the ribs 140 and the skin of the object may be relatively large. In such case, the frictional resistance between the skin and the cap 10 may not be sufficiently reduced. The dimension and the shape of the ribs in accordance with the embodiments of the present invention can also ensure the smoothness between the skin and the cap 10 in addition to effectively protecting the skin of the object.

It should be appreciated that the above described range of the proportion a is only exemplary. Further, the range of the proportion a may change depending on the usage environments in different personal care devices. The present invention is not restricted in this regard.

As shown in FIG. 5, in some embodiments, the convex surfaces 125, 126 may include circular surfaces. It should be understood that the circular here is not in the strictest sense. In some embodiments, the convex surfaces 125, 126 may be substantially circular. In other embodiments, the convex surfaces 125, 126 may be a combination of circles and straight lines. In some further embodiments, the convex surfaces 125, 126 may be a part of an elliptical shape. It is appreciated that the forms of the convex surfaces listed here are non-restrictive and the specific shapes may be modified in accordance with the shape of the cutting head of the hair cutter that matches with the cap 10.

In some embodiments, a plurality of ribs 140 may be provided in parallel on the main surface 120 with the same interval. The above arrangement may be easily manufactured, meaning that the cap 10 may be obtained at a lower cost. In some further embodiments, a plurality of ribs 140 may also be provided in parallel on the main surface 120 with different intervals. In this way, the ribs 140 are arranged in a more flexible way to broaden its range of application.

In some embodiments, the cap 10 also may include a coating provided on the main surface 120, to further enhance the smoothness between the cap 10 and the skin of the object. The user experience is also improved as a result.

In some embodiments, the cap 10 may be made of thermoplastic materials, which may be ABS. It is to be understood that the material listed here is only exemplary, rather than restrictive. In view of the different requirements, the cap 10 also may be made of other materials, including but not limited to, polypropylene (PP), polyamide (PA), polyformaldehyde (POM), polycarbonate ester (PC), PETG, polylactic acid (PLA), synthetic rubber (TPE) and polyethylene (PE), etc. The specific materials are not restricted by the embodiments of the present invention.

Embodiments of the present invention also relate to a hair cutter including the cap 10 described above. It should be understood that the cap 10 in accordance with the embodiments of the present invention may be applied into various personal care devices, e.g., shavers, epilators, facial cleansing instruments and the like.

In accordance with the solution of the present invention, a cap 10 is provided for the hair cutter at a low cost. As such, the contact area between the hair cutter and the skin is reduced in comparison to the traditional hair cutter, and the mutual slide between the moist skin and the hair cutter also decreases accordingly. By reducing the friction between the cap 10 and the skin of the object, more comfortable hair cutting operations are provided without compromising the hair cutting performance.

Although the claims of the present application are formulated against specific feature combinations, it should be understood that the scope of the present invention also includes any novel features explicitly or implicitly disclosed or summarized by the present invention, or any novel combinations regardless of whether they relate to the same solutions in any of the current claims.

1. A cap for a hair cutter, comprising:
a body comprising a main surface arranged to face towards a subject during use; and
a protrusion protruding from the main surface along a first direction perpendicular to the main surface,
wherein the protrusion comprises a plurality of ribs extending along a second direction perpendicular to the first direction, the plurality of ribs parallel to each other and spaced apart from each other in a third direction perpendicular to the first and second directions wherein the main surface has a length in the third direction that is greater than a width in the second direction;
wherein each of the plurality of ribs has a length in the second direction greater than a width in the third direction; and
wherein each of the plurality of ribs has a top that is substantially parallel to the main surface
such that, during use of a hair cutter with the cap attached, the contact area between the hair cutter and the skin is reduced, and the mutual slide between moist skin and the hair cutter is decreased accordingly, without compromising the hair cutting performance.

2. The cap of claim 1, wherein a first length of the main surface along the third direction is greater than a second length of the main surface along the second direction.

3. The cap of claim 2, wherein the width of each of the plurality of ribs decreases along the first direction when viewed in a section perpendicular to the second direction.

4. The cap of claim 1, wherein each of the plurality of ribs comprise a lateral surface adjacent to the main surface of the body, an angle between the lateral surface and the main surface ranging from 90 to 140 degrees.

5. The cap of claim 1, wherein the body comprises first and second side portions, wherein the first and second side portions are separated from each other along the second direction or the third direction and each has a convex surface protruding outwardly from the main surface.

6. The cap of claim 5, wherein the body comprises an intermediate portion connecting the first and second side portions, the main surface being provided on the intermediate portion.

7. The cap of claim 1, wherein each of the plurality of ribs comprises a bottom, wherein a total surface area of the plurality of ribs at a section at a distance from the top is 10% % of a surface area of the main surface.

8. The cap of claim 7, wherein the distance is 0.2 mm.

9. The cap of claim 5, wherein the convex surfaces are circular surfaces.

10. The cap of claim 1, wherein the plurality of the ribs are provided in parallel on the main surface with the same interval or different intervals.

11. The cap of claim 1, wherein a coating provided on the main surface.

12. The cap of claim 1, wherein the cap is made of a thermoplastic material.

13. A hair cutter, characterized by comprising a cap of claim 1.
